(19) United States
(12) Patent Application Publication
(10) Pub. No.: US 2023/0006240 A1
(43) Pub. Date: Jan. 5, 2023

(54) SEMI-INTERPENETRATING POLYMER NETWORKS BASED ON POLYCARBONATES AS SEPARATORS FOR USE IN ALKALI-METAL BATTERIES

(71) Applicant: FORSCHUNGSZENTRUM JÜLICH GMBH, Jülich (DE)

(72) Inventors: Gerrit HOMANN, Münster (DE); Johannes KASNATSCHEEW, Dülmen (DE); Lukas STOLZ, Münster (DE); Mariano GRÜNEBAUM, Nordkirchen (DE); Martin WINTER, Münster (DE)

(21) Appl. No.: 17/781,262

(22) PCT Filed: Nov. 20, 2020
(86) PCT No.: PCT/EP2020/082964

§ 371 Date: May 31, 2022

(30) Foreign Application Priority Data
Nov. 28, 2019 (DE) 10 2019 132 370.3

(51) Int. Cl. H01M 10/056; H01M 10/052

(52) U.S. Cl. CPC H01M 10/056; H01M 10/052; H01M 2300/0065

(57) ABSTRACT

A solid electrolyte for an alkali metal solid state battery, the solid electrolyte comprising a mixture of two different alkali metal conducting salts and a semi-interpenetrating network (sIPN) of a crosslinked and a non-crosslinked polymer, wherein the semi-interpenetrating network is greater than or equal to 50 wt.-% and less than or equal to 80 wt.-% of a non-crosslinked polymer selected from the group consisting of polyethylene oxide (PEO), polycarbonate (PC), polycaprolactone (PCL), chain end modified derivatives of these polymers or mixtures of at least two components thereof; and greater than or equal to 10 wt.-% and less than or equal to 50 wt.-% of a polycarbonate of crosslinkable polyalkyl carbonate monomers having a carbon number greater than or equal to 2 and less than or equal to 15 based on the single monomer as the crosslinked polymer.

### INTRODUCTION

The present disclosure relates to solid electrolyte for an alkali metal solid state battery, the solid electrolyte comprising a mixture of two different alkali metal conducting salts and a semi-interpenetrating network (sIPN) of a crosslinked and a non-crosslinked polymer, wherein the semi-interpenetrating network is greater than or equal to 50 wt.-% and less than or equal to 80 wt.-% of a non-crosslinked polymer selected from the group consisting of polyethylene oxide (PEO), polycarbonate (PC), polycaprolactone (PCL), chain end modified derivatives of these polymers or mixtures of at least two components thereof; and greater than or equal to 10 wt.-% and less than or equal to 50 wt.-% of a polycarbonate of crosslinkable polyalkyl carbonate monomers having a carbon number greater than or equal to 2 and less than or equal to 15 based on the single monomer as the crosslinked polymer, wherein the single polyalkyl carbonate monomer may be substituted or unsubstituted and comprises two crosslinkable groups selected from the group consisting of acrylic, methacrylic, epoxy, vinyl, isocyanide or mixtures of two different groups thereof. Furthermore, the present disclosure relates to an alkali metal battery having a solid electrolyte.

Increased user demands for sustainability and mobility have significantly changed the landscape of decentralized energy storage in recent decades. Whereas in the past the possibilities for the technical use of batteries were significantly limited due to their size, weight and only very limited electrical capacity, since the use of alkali metal-based energy storage systems, for example in the form of rechargeable lithium batteries, the possible applications have increased significantly. Since their market launch in the early 1990s, lithium-ion batteries have made mobile applications such as smartphones and laptops suitable for mass use. Continuous further developments have also led to an increase in energy densities and application reliability. It is precisely these optimization steps that have contributed to the fact that lithium-ion batteries, for example, are nowadays considered as stationary energy storage devices for decentrally generated electricity in the private and industrial sectors. Furthermore, these innovative electrical storage systems form the basis of new, climate-friendly transport concepts in the field of electromobility.

For secondary alkaline batteries, in addition to batteries with liquid electrolytes, polymer-based solid batteries with high-viscosity “solid” electrolytes are also known. Usually, the optimum operating temperatures of these types are in the range of around 60° C., but an extension of the possible operating temperature window to lower temperatures, for example to a temperature range of around 40° C. or even 20° C., is sought. The most popular representative of this class of electrolytes is polyethylene oxide (PEO), which, using at least one lithium conducting salt, is assumed to be oxidatively unstable (above 3.9 V vs. Li/Li+) but is a cheap and readily available standard. Since PEO is easy to process and can also be readily produced on an industrial scale, many efforts are being made to produce PEO-based polymer electrolytes. Usually, lithium iron phosphate (LFP) is used as the positive electrode, since this electrode material has sufficiently good compatibility with PEO.

When PEO is used as the polymer electrolyte, even at an operating temperature of 60° C. above 3.9 V, short circuits of the battery cells occur after repeated charge/discharge cycles. This situation becomes even more unfavorable for high-voltage electrodes, for example with NMC (lithium nickel manganese cobalt oxide) electrodes, because inhomogeneous charge states occur in the electrolyte and at the electrode. Also, PEO-conducting salt combinations are known to exhibit various crystalline and amorphous phases without further additives, which make inhomogeneous Li-ion transport likely. These factors currently stand in the way of unhindered commercial use of solid electrolytes in a wide temperature range and with high-voltage electrodes.

Some approaches to improving alkali solid electrolytes can also be found in the patent literature.

For example, WO 2014 147 648 A1 discloses a high ionic conductivity electrolyte composition. In particular, the document discloses high ionic conductivity electrolyte compositions of semi-interpenetrating polymer networks and their nanocomposites as quasi-solid/solid electrolyte matrix for power generation, storage and delivery devices, in particular for hybrid solar cells, accumulators, capacitors, electrochemical systems and flexible devices. The binary or ternary component of a semi-interpenetrating polymer network electrolyte composition comprises: (a) a polymer network with polyether backbone (component I); (b) a linear, branched, hyperbranched polymer with low molecular weight or any binary combination of such polymers with preferably non-reactive end groups (component II and/or component III to form a ternary semi-IPN system); (c) an electrolyte salt and/or a redox couple; and optionally (d) a pure or surface-modified nanostructured material to form a nanocomposite.

WO 2015 043 564 A1 discloses a method of manufacturing at least one electrochemical cell of a solid-state battery comprising a mixed-conducting anode, a mixed-conducting cathode, and an electrolyte layer disposed between the anode and the cathode, comprising the steps,
a mixed conducting anode is produced or provided,
a mixed conducting cathode is produced or provided,
the surface of at least one of the two electrodes is modified by an additional process step in such a way that the electronic conductivity perpendicular to the cell is lowered to less than 10 ⁸S/cm in a layer of the electrode near the surface, and—subsequently, the anode and the cathode are assembled to form a solid-state battery in such a way that the surface-modified layer of at least one electrode is arranged at the boundary between the anode and the cathode as an electrolyte layer, and the mixed-conducting electrodes are thereby electronically separated.

Such solutions known from the prior art may offer further potential for improvement, especially with regard to improved reproducibility of charging and discharging processes of secondary alkaline batteries.

### SUMMARY

It is the task of an embodiment of the present disclosure to at least partially overcome the disadvantages known from the prior art. In particular, it is the task of the present disclosure to provide a solution by which improved charge and discharge stability is provided even after repeated cycles.

According to an embodiment, the problem is solved by a solid electrolyte. According to an embodiment, the problem is further solved by an alkali metal battery.

According to an embodiment is a solid electrolyte for an alkali metal solid state battery, the solid electrolyte comprising a mixture of two different alkali metal conducting salts and a semi-interpenetrating network (sIPN) of a cross-linked and a non-cross-linked polymer, wherein the semi-interpenetrating network is greater than or equal to 50 wt.-% and less than or equal to 80 wt.-% of a non-crosslinked polymer selected from the group consisting of polyethylene oxide (PEO), polycarbonate (PC), polycaprolactone (PCL), chain end modified derivatives of these polymers or mixtures of at least two components thereof; and greater than or equal to 10 wt.-% and less than or equal to 50 wt.-% of a polycarbonate of crosslinkable polyalkyl carbonate monomers having a carbon number greater than or equal to 2 and less than or equal to 15 based on the single monomer as the crosslinked polymer, wherein the single polyalkyl carbonate monomer may be substituted or unsubstituted and comprises two crosslinkable groups selected from the group consisting of acrylic, methacrylic, epoxy, vinyl, isocyanide or mixtures of two different groups thereof.

Surprisingly, it was found that the above structure of a solid electrolyte from a semi-interpenetrating network based on crosslinked polycarbonates and non-crosslinked PEO in combination with a dual conducting salt leads to significantly improved properties for the formed solid electrolyte. In contrast to a pure solid electrolyte based on PEO, the solid electrolyte has significantly higher mechanical stability. The higher mechanical stability in combination with the double conducting salt also means that the electrical properties of the solid electrolyte and batteries manufactured with it are significantly more reproducible than those of batteries that are either based only on polyethylene oxide or have only a single conducting salt. The number of cycles achievable under the same electrical conditions and the service life of batteries are thus significantly increased by the structure according to an embodiment. Another advantage of this solid electrolyte is, per an embodiment, that it can also be operated with improved properties in a lower temperature window. Without being bound by theory, the approximately equal polarity of the polycarbonates used according to an embodiment to the PEO appears to be decisive for very good miscibility, which leads to particularly homogeneous mixing and ultimately to the formation of stable and homogeneous networks. At the same time, carbonate groups exhibit weak coordination to alkali ions, which leads to the alkali ions of the conducting salts coordinating primarily to the added alkali ion-conducting polymer electrolyte, e.g. PEO, and not being retained at the relatively inflexible carbonate backbone of the network former.

The solid electrolyte according to an embodiment is a solid electrolyte for an alkali metal solid state battery. A solid electrolyte is also called a solid electrolyte, solid electrolyte or solid ionic conductor. The solid electrolyte has a coherent polymeric support structure and alkali metal ions embedded therein, which are mobile within the polymeric matrix of the solid electrolyte. An electric current can flow via the mobility of the ions in the solid electrolyte. Solid electrolytes are electrically conductive, but show rather low electronic conductivity compared to metals. An alkali metal solid battery has at least two electrodes and a solid, in particular non-flowing electrolyte arranged between the electrodes. In addition to these components, a solid-state battery may have other layers or sheets. For example, a solid-state battery may have other layers between the solid electrolyte and the electrodes. The electrical properties of alkali metal solid state batteries are based on the redox reaction of alkali metals, i.e., the metals from the 1^{st} main group of the periodic table. In particular, lithium, sodium and potassium can be used as alkali metals.

The solid electrolyte according to an embodiment comprises a mixture of two different alkali metal conducting salts. The alkali metal conducting salts consist essentially of alkali metal cations and inorganic or organic anions. For the formation of a mixture of two different alkali metal conducting salts, it is sufficient in the sense of an embodiment if the two conducting salts have identical cations but different anions. In this respect, the solid electrolyte according to an embodiment can comprise only one cation species, for example lithium, but in contrast two different anions. The amounts of the two different alkali metal conducting salts used need not be equimolar. It is also possible that the two different alkali metal conducting salts are used in different concentrations. In the sense of an embodiment, a mixture of two different alkali metal conducting salts is present if one of the two alkali metal conducting salts constitutes at least 10 mol %, preferably 15 mol %, preferably 20 mol % of the total amount of alkali metal conducting salt. Possible anions may be selected from the group consisting of hexafluorophosphates, perchlorates, tetrafluoroborates, tris(pentafluoroethyl)trifluorophosphates, trifluoromethanesulfonates, bis(fluorosulfonyl)imides, bis(fluoromethanesulfonyl)imides, bis(perfluoroethanesulfonyl)imides, bis(oxalate)borate, difluoro(oxalato)borate, bis(fluoromalonato)borate, tetracyanoborate, dicyanotriazolate, dicyano-trifluoromethyl-imidazole, dicyano-pentafluoroethyl-imidazole, fluorosulfonyl-(trifluoromethanesulfonyl)imide or mixtures of at least two components thereof. Furthermore, at least one of the conducting salts used may contain an anion with crosslinkable functionalization, for example a methacrylate group.

The solid electrolyte comprises a semi-interpenetrating network (sIPN) of a crosslinked and a non-crosslinked polymer. The basic mechanical structure of the solid electrolyte is formed by a network of two different polymers, which also gives it its strength. A semi-interpenetrating network is one that comprises two different polymer species. One polymer can be crosslinked to form a three-dimensional network by forming covalent bonds between the monomers, whereas the other polymer, in the absence of functional groups, is linked purely by ionic or van der Waals interactions. Both polymer components can, at least in principle, be separated from each other by a washout process. Due to the fact that crosslinking of the functional groups of the crosslinkable polymer occurs only after a physical mixing process with the non-crosslinkable polymer, both components physically interpenetrate and together form the semi-interpenetrating network. The other components of the solid electrolyte are the alkali metal conducting salts, which are present “dissolved” within the network or bonded to it, but which, according to an embodiment, are not regarded as a component of the semi-interpenetrating polymer network but as a component of the solid electrolyte.

The semi-interpenetrating network comprises greater than or equal to 50 wt.-% and less than or equal to 80 wt.-% of a non-crosslinked polymer selected from the group consisting of polyethylene oxide (PEO), polycarbonate (PC), polycaprolactone (PCL), chain end modified derivatives of these polymers or mixtures of at least two components thereof. Thus, the semi-interpenetrating network constructed from two polymeric components has PEO, PC, PCL or mixtures of these components as the main weight component. These polymers, which cannot be crosslinked and are not crosslinked in the network, can each be substituted at the chain ends by functional groups.

PEO refers to monomers with the following structural formula

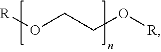

where the index n can suitably be selected from 10 to 120000. The radicals R may each independently of one another be hydrogen or a substituted or unsubstituted alkyl or aryl radical. The substituted or unsubstituted alkyl or aryl radicals may have a C number of C1 to C20 and may have further, non-crosslinkable functional substituents, such as halogen, OH, NH₃, NO₂.

Polycarbonates are compounds with the following structural formula

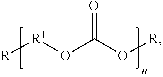

where the index n can be suitably selected from 3 to 120000. The radicals R at the chain ends correspond to the above definition. The group R¹ stands for an aromatic or aliphatic C1-C15 group.

Polycaprolactone refers to compounds with the following structural formula

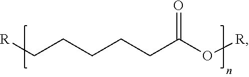

where the index n can be suitably selected from 3 to 120000. The residues R at the chain ends correspond to the above definition.

As a further component, the sIPN has greater than or equal to 10 wt.-% and less than or equal to 50 wt.-% of a polycarbonate of crosslinkable polyalkyl carbonate monomers with a carbon number greater than or equal to 2 and less than or equal to 15 based on the individual monomer as crosslinked polymer. The crosslinkable component of the semi-interpenetrating network thus comprises carbonate monomers which can be crosslinked to one another via functional groups in the monomer. In this way, an insoluble covalent crosslinked structure can be formed within the semi-interpenetrating network, which can increase the mechanical stability of the network. Preferably, per an embodiment, a carbonate monomer may bear two crosslinkable groups, in particular two crosslinkable terminal groups. However, it is also possible for the carbonate monomer to have more than two functional groups. The weight ratios given above refer to the components of the semi-interpenetrating network and, in particular, do not include the portions of the solid electrolyte which are introduced via the alkali metal conducting salts. Possible polycarbonate base monomers, without functional groups, are, for example, straight-chain or branched alkyl polycarbonates with a carbon number of up to 15 between the carbonate groups. The molecular weight of the polyalkyl carbonate monomers can range from 100 g/mol to 5000 g/mol without the crosslinking functionalization.

The single polyalkyl carbonate monomer may be substituted or unsubstituted and comprise two crosslinkable groups selected from the group consisting of acrylic, methacrylic, epoxy, vinyl, isocyanide or mixtures of two different groups thereof. The polyalkyl carbonate monomers can thus carry such, still further functional groups, such as OH, NH₃, CHO groups. However, in addition to this general substitution of the basic skeleton of the monomer, the polyalkyl carbonate monomer has at least two crosslinkable functional groups from functional groups indicated above. These functional groups result in the formation of covalent bonds between the individual polycarbonate monomers.

In an embodiment of the solid electrolyte, the weight fraction of the crosslinked to the uncrosslinked polymer in the sIPN can be greater than or equal to 20 wt.-% and less than or equal to 40 wt.-%. The concentration and miscibility of the individual components play an important role in producing a sufficiently stable, sponge-like structure of the network former within the polymer film. Thus, from the concentration range of more than 20 wt.-% polycarbonate network former (based on PEO) indicated above, significantly increased reproducibilities are observed compared to the pure PEO conducting salt standard. Furthermore, a possibly reduced overall conductivity due to the use of polycarbonate network formers can be compensated by increasing the salt content to such an extent that no capacity losses due to increased cell resistance are obtained at 60° C. compared to pure PEO-conducting salt combinations.

Within an embodiment of the solid electrolyte, the molecular weight of the polyalkyl carbonate monomers may be greater than or equal to 100 g/mol and less than or equal to 3500 g/mol. The investigation of different chain lengths of the polyalkyl carbonate monomers has shown that improved electrochemical performance can be obtained with lower chain lengths of the polyalkyl carbonate monomers. Apparently, the stability of the sIPN is higher with shorter chain lengths and thus squeeze-induced short circuits of battery assemblies with the solid electrolyte of an embodiment can be avoided.

In an embodiment of the solid electrolyte, the polyalkyl carbonate monomers may be selected from the group consisting of straight-chain or branched, substituted or unsubstituted polyethylene, polymethylene, polypropylene, polybutylene, polyhexylene carbonates, or mixtures of at least two components thereof. Examples of these polyalkyl carbonate monomers may include polyethylene carbonate (PEC), polypropylene carbonate (PPC), or polytrimethylene carbonates (PTMC), each having a molecular weight in the range of 500 g/mol to 5000 g/mol. Preferably, per an embodiment, the molecular weight of the polyalkyl carbonate monomers may be in the range of 500 g/mol up to 2000 g/mol. These alkyl polyalkyl carbonate monomers can provide particularly preferred mechanical properties of the matrix and particularly suitable electrical properties of the solid electrolyte, per an embodiment.

Within an embodiment of the solid electrolyte, the polyalkyl carbonate monomers can each carry two identical functional groups and the functional group can be a methacryl group. Symmetrical functionalization of the polyalkyl carbonate monomers via two methacryl groups has proved to be particularly suitable for obtaining mechanically stable semi-interpenetrating networks. In this respect, the individual monomer carries two methacryl groups, preferably two terminal methacryl groups. Due to the particular mechanical stability of the semi-interpenetrating networks that form, the service life of the solid electrolyte can be significantly increased, per an embodiment.

Within an embodiment of the solid electrolyte, the mixture of two different alkali metal conducting salts may include at least the salts alkali (fluorosulfonyl)(tri-fluoromethanesulfonyl)imide (FTFSI) and alkali bis(trifluoromethanesulfonyl)imide) (TFSI). The combination of both alkali metal conducting salts mentioned above has been found to be particularly suitable for obtaining long-lasting and efficient batteries. The solid electrolytes exhibit excellent conductivity and the time periods until electrical failure of battery assemblies with these solid electrolytes could be significantly extended. Particularly suitable mixtures of both conducting salts have a proportion of FTFSI between 0.1 wt.-% and 5 wt.-% and a proportion of TFSI from 15 wt.-% to 60 wt.-% based on the weight of the sIPN including the conducting salts. In particular, the proportion of both conducting salts can be from 5 wt.-% up to 70 wt.-% based on the weight of the sIPN including the conducting salts. Furthermore, conducting salts with crosslinkable anion have proven to be particularly advantageous, per an embodiment, since the electrostatic interactions between the sIPN and the immobilized anion can counteract excessive deformation of the sIPN. The use of crosslinkable conducting salts in the sIPN built up according to an embodiment represents a particular advantage, since this addition further supports the formation of a highly amorphous, cation-conducting polymer phase. The formation of such mechanically stable, amorphous structures is not feasible with prior art compositions.

In another embodiment of the solid electrolyte, the weight ratio of alkali (fluorosulfonyl) (trifluoromethanesulfonyl)imide (FTFSI) to the weight sum of the components of sIPN and the further conducting salt, expressed as the weight of alkali FTFSI divided by the sum of the weights of sIPN and further conducting salt, may be greater than or equal to 0.005 and less than or equal to 0.1. Within this ratio of FTFSI and sIPN including the further conducting salt, particularly favorable electrical properties of the solid electrolyte with long service lives can be obtained. In a further embodiment, the ratio may be greater than or equal to 0.01 and less than or equal to 0.075. The carbonyl groups of the network former have an overall weaker affinity for the Li⁺ in the electrolyte than the linear PEO polymer, whereby the coordination of Li⁺ preferentially occurs at the linear PEO polymer. This allows the use of lower salt concentrations compared to pure polyethers or polyethers as network formers using the same salt concentrations.

In a further embodiment, the solid electrolyte may be a solid electrolyte for a Li-solid battery. Due to the improved mechanical and electrical properties of the solid electrolyte, the solid electrolytes according to an embodiment are particularly suitable for the electrically highly demanding applications in lithium-based battery types.

Further according to an embodiment is an alkali metal battery comprising an anode, a cathode and a solid electrolyte arranged between anode and cathode, wherein the solid electrolyte is a solid electrolyte according to an embodiment. For the advantages of the alkali metal batteries according to an embodiment, explicit reference is made to the advantages of the process according to the invention and the polymeric solid electrolyte according to an embodiment. The batteries may generally have other layers in addition to the components mentioned.

Materials for all-solid-state lithium-ion batteries or lithium-metal batteries can be used for the positive electrode of the alkali-metal battery in an embodiment as a Li-metal battery. In this regard, the electrode layer includes active materials such as LiNiₓMn_{y}Co₂O₂ (NMC), LiCoO₂ (LCO), LiFePO₄ (LFP), or LNiₓMn_{y}O₄ (LNMO). In addition, the positive electrode may further comprise binder, electronically conductive material to increase electronic conductivity, e.g. acetylene black, carbon black, graphite, carbon fiber and carbon nanotubes, and electrolyte material, in particular a polymer or solid electrolyte, to increase ionic conductivity, as well as other additives.

In an embodiment of the alkali metal battery, the battery may be a Li metal battery and the battery may have at least one high current or high voltage electrode. The suitability results in particular from the high mechanical strength, as well as on the fact that the solid electrolyte is also suitable for use with high current or high voltage electrodes. High-current electrodes are electrodes that can provide a specific capacity of more than 100 mAh g⁻¹ with a charging time of less than or equal to 15 hours. High-voltage electrodes can provide a final charging voltage of ≥4V.

In an embodiment, the solid electrolyte according to an embodiment can be used in electrochemical devices. Electrochemical devices may include fuel cells or capacitors in addition to primary and secondary batteries. Furthermore, the solid electrolyte according to an embodiment can be used in electrochemical devices as a layer to improve the electrical contacting (“wetting”) of electrodes.

In addition to use as a polymer electrolyte separating layer in lithium metal batteries, in which the polymer electrolyte according to an embodiment has direct contact with the cathode, use in sulfide-based solid electrolyte cells is also possible. This cell concept can also be transferred to oxide-based ceramics, where the polymer electrolyte can act as a wetting aid to the lithium metal side. The use of several different polymer layers for anode and cathode is also possible. As an alternative to thermal radical polymerization, photopolymerization is also conceivable, in which a UV light source is used to initiate polymerization. Also, the addition of short-chain polyethylene glycol derivatives to enable a lower operating temperature. The sIPN of the invention can also be used to finish other coating substrates such as siloxided paper, polyethylene/polypropylene films, PTFE or even glass or chemical surfaces such as modified glass.

### BRIEF DESCRIPTION OF THE FIGURES

These and other aspects of the invention will be apparent from and elucidated with reference to the figures and examples described hereinafter, wherein even individual features disclosed in the figures and the examples and in the disclosure as a whole can constitute an aspect of the present invention alone or in combination, wherein additionally, features of different embodiments can be carried over from one embodiment to another embodiment without leaving the scope of the present invention.

In the drawings:

FIGS. 1 shows the result of a Li plating/stripping experiment of a cell assembly not according to an embodiment as a function of time;

FIG. 2 shows the result of galvanostatic cycling of a cell assembly not according to an embodiment as a function of time;

FIG. 3 shows the result of a Li plating/stripping test once of a cell assembly not according to an embodiment and once of a cell assembly according to an embodiment with a dual salt electrolyte as a function of time;

FIG. 4 shows the result of galvanostatic cycling of a cell assembly not according to an embodiment and a cell assembly according to an embodiment with a dual-salt electrolyte as a function of time; and

FIG. 5 shows the result of a mechanical stability test, once of a cell structure not according to an embodiment and once of a cell structure according to an embodiment, as a function of the pressure deflection.

### DETAILED DESCRIPTION

### EXAMPLS

### I. Preparation of the Solid Electrolytes

An sIPN for a Li battery is produced.

I.a. Synthesis of the Polycarbonate Network Former

The synthesis of the polycarbonate network former is carried out under inert gas. 10 g poly(l,6-hexanediol)carbonate diol (Mw=1000 g/mol) are dissolved in dry dichloromethane (100 mL). Approximately 0.5 g magnesium sulfate is added to dry the polycarbonate and the mixture is stirred overnight. The mixture is filtrated to remove the magnesium sulfate. DMAP (4-(dimethylamino)pyridine) (0.001 mol % per terminal hydroxyl group), and triethylamine (2 equivalents based on terminal hydroxyl groups) are then added. With stirring and cooling to 0° C., methacryloyl chloride (1.2 equivalents based on terminal hydroxyl groups) is carefully added. The reaction mixture is stirred at room temperature for three days. The crude product is washed 5 times with 2M aqueous HCl solution (5×50 mL) to extract from the organic phase the polar reactants and by-products of the reaction. A separatory funnel is used for phase separation. The organic phase was dried over magnesium sulfate and the solvent was removed under reduced pressure. The product is dried under vacuum at RT for several days. The dried product is stored under inert gas.

I.b. Preparation of an SIPN according to the Invention

The conducting salt combination in the molar ratio of 13 parts Li-TFSI (0.289 g) to 1 part Li-FTFSI (0.018 g) is dissolved together with polycarbonate (poly(l,6-hexanediol) carbonate dimethacrylate) (0.125 g) and the radical initiator AIBN (azobisisobutyronitrile) (0.018 g) in 3 mL acetonitrile or THF as solvent and then the PEO powder (0.5 g) is added. The mixture with a conducting salt to polymer ratio of 1 to 3 is stirred for several hours and, after complete homogenization, can be applied to a Mylar film by film casting in basically any thickness. The solvent is evaporated in a fume hood, the polymer film produced is polymerized at 70° C. under nitrogen flow for one hour and then dried overnight under vacuum. Possible thicknesses for the solid electrolyte range from greater than or equal to 1 μm to less than or equal to 500 μm.

I.c. Production of a Battery

For use in lithium metal battery cells, a round piece of polymer film 200 μm high and 17 mm in diameter is die-cut and used analogously to a separator between lithium metal electrode and positive electrode consisting of 91 wt % LiNi_{0.6}Mn_{0.2}Co_{0.2}O₂, 4 wt.-% carbon black and wt.-% PVdF. Lithium metal battery cells prepared in this way were tested at 60° C.

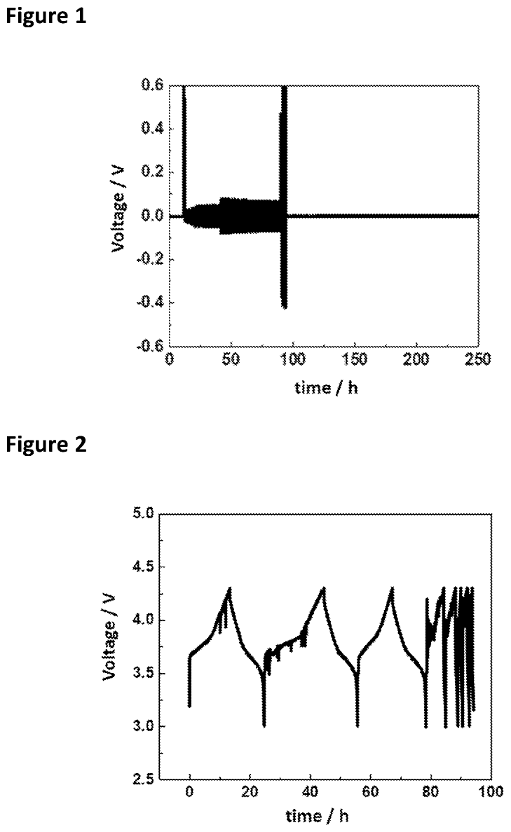

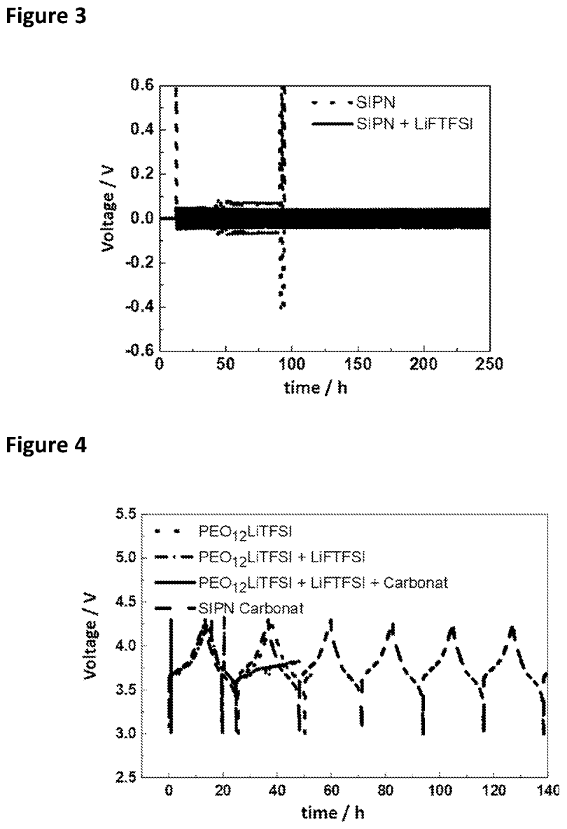

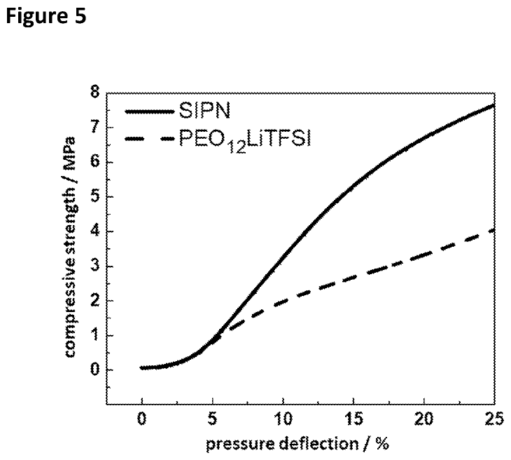

The electrochemical behavior of battery assemblies according to an embodiment and those not according to an embodiment is shown in FIGS. 1 to 5. It shows the
FIG. 1 the result of a Li plating/stripping experiment of a cell assembly not according to an embodiment as a function of time;
FIG. 2 the result of galvanostatic cycling of a cell assembly not according to an embodiment as a function of time;
FIG. 3 the result of a Li plating/stripping test once of a cell assembly not according to an embodiment and once of a cell assembly according to an embodiment with a dual salt electrolyte as a function of time;
FIG. 4 the result of galvanostatic cycling of a cell assembly not according to an embodiment and a cell assembly according to an embodiment with a dual-salt electrolyte as a function of time;
FIG. 5 the result of a mechanical stability test, once of a cell structure not according to an embodiment and once of a cell structure according to an embodiment, as a function of the pressure deflection.

FIG. 1 shows the voltage response of a Li ∥ Li cell with an s-IPN without the use of two different electrolytes. The two Li electrodes are used alternately for one hour each as positive and negative electrode under the influence of a constant current of 50 μA/cm², whereby Li is alternately transported from one side to the other through the electrolyte. The cell shows cell failure after a relatively short time of 100 h, which is due to a short circuit.

FIG. 2 shows the voltage behavior of a conventional galvanostatic cycling of a Li ∥ NMC622 cell with a polymer electrolyte of PEO and polycarbonate, but with only one conducting salt (Li-TFSI) in a concentration of 30 wt.-% conducting salt to the total weight of the s-IPNs. The weight ratio of PEO to polycarbonate here is 1 to 4. This cell also shows a time-dependent error, evident from the noise in the voltage curve.

FIG. 3 shows the voltage curve of a Li plating/stripping experiment as a function of time, once for a cell setup according to an embodiment and once for a cell setup not according to an embodiment. The same Li ∥ Li cell assembly was run with the same s-IPN but once, according to an embodiment, with Li-FTFSI/Li-TFSI as “dual salt” electrolyte and once with only Li-TFSI as electrolyte. It can be clearly seen that the dual salt approach with Li-FTFSI and Li-TFSI runs significantly longer and without failure. Without being bound by theory, it is suspected that the Li electrode is stabilized by the combination of the s-IPN with Li-FTFSI and Li-TFSI.

FIG. 4 shows the result of galvanostatic cycling of a Li ∥ NMC622 cell with different compositions of the solid electrolytes. If PEO and Li-TFSI alone are used (PEO₁₂LiTFSI), the battery cell already exhibits a defect at the beginning of the cyclization, presumably caused by a short circuit. The addition of another lead salt only to PEO as the sole polymer (LiFTFSI+PEO₁₂LiTFSI) shows no significant improvement in electrical behavior and the cell fails after a short time. The addition of carbonate to Li-FTFSI in PEO₁₂LiTFSI without formation of a semi-interpenetrating network, i.e. without crosslinking of the individual polycarbonate monomers, also shows no improvement in electrical behavior. Only the combination of two different electrolytes (Li-FTFSI and TFSI) and the formation of a semi-interpenetrating network of PEO and crosslinked polycarbonate, on the other hand, shows error-free cycling over the entire measurement period.

FIG. 5 shows a mechanical stability test of a solid electrolyte according to an embodiment and one not according to an embodiment. By using solid electrolytes according to an embodiment with an sIPN of crosslinked polycarbonates and non-crosslinked PEO, a significant improvement in compressive strength is shown compared to only a PEO network. The compressive strength was determined using a compressibility test rig, in which a polymer sample of 2 mm height and 18 mm diameter is compressed between two stainless steel plates under a constant feed rate of 20 μm/min and the force required to achieve this is measured. This improved compressive strength, together with the dual salt approach, could be the reason for the improved Li compatibility and error-free cycling of Li ∥ NMC622 cells.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. Solid electrolyte for an alkali metal solid state battery, wherein the solid electrolyte comprises a mixture of two different alkali metal conducting salts and a semi-interpenetrating network (sIPN) of a crosslinked and a non-crosslinked polymer, wherein the semi-interpenetrating network comprises:
greater than or equal to 50 wt.-% and less than or equal to 80 wt.-% of a non-crosslinked polymer selected from the group consisting of polyethylene oxide (PEO), polycarbonate (PC), polycaprolactone (PCL), chain end modified derivatives of these polymers, or mixtures of at least two components thereof; and
greater than or equal to 10 wt.-% and less than or equal to 50 wt.-% of a polycarbonate of crosslinkable polyalkyl carbonate monomers having a carbon number greater than or equal to 2 and less than or equal to 15 based on the single monomer as the crosslinked polymer, wherein the single polyalkyl carbonate monomer may be substituted or unsubstituted and comprises two crosslinkable groups selected from the group consisting of acrylic, methacrylic, epoxy, vinyl, isocyanide or mixtures of two different groups thereof

2. The solid electrolyte according to claim 1, wherein the weight fraction of crosslinked to uncrosslinked polymer in the sIPN is greater than or equal to 20 wt.-% and less than or equal to 40 wt.-%.

3. The solid electrolyte according to claim 1, wherein the molecular weight of the polyalkyl carbonate monomers is greater than or equal to 100 g/mol and less than or equal to 3500 g/mol.

4. The solid electrolyte according to claim 1, wherein the polyalkyl carbonate monomers are selected from the group consisting of straight-chain or branched, substituted or unsubstituted polyethylene, polymethylene, polypropylene, polybutylene, polyhexylene carbonates or mixtures of at least two components thereof.

5. The solid electrolyte according to claim 1, wherein the polyalkyl carbonate monomers each carry two identical functional groups and the functional group is a methacryl group.

6. The solid electrolyte according to claim 1, wherein the mixture of two different alkali metal conducting salts comprises at least the salts alkali (fluorosulfonyl) (trifluoromethanesulfonyl)imide (FTFSI) and alkali bis(trifluoromethanesulfonyl)imide) (TFSI).

7. The solid electrolyte according to claim 6, wherein the weight ratio of alkali (fluorosulfonyl) (trifluoromethanesulfonyl)imide (FTFSI) to the weight sum of the components of sIPN and the further conducting salt, expressed as the weight of alkali FTFSI divided by the sum of the weights of sIPN and further conducting salt, is greater than or equal to 0.005 and less than or equal to 0.1.

8. The solid electrolyte according to claim 1, wherein the solid electrolyte is a solid electrolyte for a Li-solid battery.

9. Alkali metal battery comprising an anode, a cathode, and a solid electrolyte disposed between the anode and the cathode, wherein the solid electrolyte is a solid electrolyte according to claim 1.

10. The battery according to claim 9, wherein the battery is a Li metal battery and the battery comprises at least one high current or high voltage electrode.
